(19) United States
(12) Patent Application Publication
(10) Pub. No.: US 2020/0047473 A1
(43) Pub. Date: Feb. 13, 2020

(54) POLYOLEFIN MICROPOROUS MEMBRANE

(71) Applicant: Toray Industries, Inc., Tokyo (JP)

(72) Inventors: Yukiko Miura, Nasushiobara (JP); Naofumi Yasuda, Nasushiobara (JP); Nobuaki Suzuki, Nasushiobara (JP)

(21) Appl. No.: 16/492,686

(22) PCT Filed: Mar. 13, 2018
(86) PCT No.: PCT/JP2018/009789

§ 371 Date: Sep. 10, 2019

(30) Foreign Application Priority Data
Mar. 17, 2017 (JP) 2017-052900

(51) Int. Cl. B32B 27/32; B01D 69/02; B01D 69/12; B01D 71/26; B32B 27/08; H01M 2/16; C08J 9/28

(52) U.S. Cl. CPC B32B 27/32; C08J 2201/0502; B01D 69/12; B01D 71/26; B32B 27/08; H01M 2/1653; H01M 2/1686; C08J 9/28; B01D 2325/34; B01D 2325/02; B01D 2325/04; B32B 2307/726; C08J 2205/042; C08J 2323/06; C08J 2323/12; B01D 69/02

(57) ABSTRACT

A polyolefin microporous membrane has a microporous structure with a small pore size and a highly superior air permeability and the like. The polyolefin microporous membrane includes at least a first layer and a second layer, wherein the first layer is composed of a first polyolefin resin containing polyethylene, wherein the second layer is composed of a second polyolefin resin containing polyethylene and polypropylene, and wherein the polyolefin microporous membrane satisfies (I) and (II); and the like. (I) The polyolefin microporous membrane has an air resistance of from 10 to 200 sec/100 ml. (II) The polyolefin microporous membrane has a bubble point pore size of from 5 to 35 nm.

### TECHNICAL FIELD

This disclosure relates to a polyolefin microporous membrane.

### BACKGROUND

Polyolefin microporous membranes are widely used in various types of applications such as, for example, battery separators, separators for electrolytic capacitors, water treatment membranes, ultrafiltration membranes, microfiltration membranes, reverse osmosis filtration membranes, waterproof and breathable clothing and the like. Among them, particularly in applications in which solvent resistance, chemical resistance and the like are required, there is a growing demand for a further improvement in the performance of polyolefin microporous membranes so that a high level of separation ability can be maintained while maintaining sufficient resistances.

For example, when used as filters for process liquids used in the production of highly integrated semiconductors, polyolefin microporous membranes are required to have a finer pore size and a better permeability to capture fine foreign substances in the process liquids, as semiconductors have an increasingly finer wiring pitch of from several hundred nm to ten-odd nm. When used as battery separators, polyolefin microporous membranes are required to have an appropriate pore size and a sufficient permeability of ions and the like suitable for when the battery separators have a reduced thickness, as lithium ion secondary batteries have an increasingly higher energy and smaller size in recent years.

JP 2002-284918 A discloses a polyolefin microporous membrane having a bubble point value of more than 980 kPa. The polyolefin microporous membrane is obtained by: melt-blending a polyolefin resin composition and a membrane-forming solvent; extruding the resulting mixture, followed by cooling, to obtain a gel-like sheet; and removing the membrane-forming solvent before and/or after stretching the gel-like sheet.

JP 11-179120 A discloses a laminated filter made of a polyolefin resin obtained by laminating and integrating a polyolefin nonwoven fabric with a polyolefin microporous membrane having an average pore size of from 0.03 to 1 μm.

JP 2010-171003 A and JP 2010-171003 A disclose polyolefin microporous membranes including a layer containing polyethylene and a layer containing polypropylene. The polyolefin microporous membranes are obtained by: coextruding a resin composition containing polypropylene and a β-crystal nucleating agent with a resin composition containing polyethylene; cooling the resulting extrudate to obtain a sheet; and stretching the resulting sheet, followed by a heat setting treatment. Further, Examples in JP 2010-171003 A and JP 2010-171003 A disclose that the resulting polyolefin microporous membranes have a bubble point pore size of 0.02 to 0.04 μm, and a Gurley value (air resistance) of 330 to 600 sec/100 mL.

However, we found that in producing a polyolefin microporous membrane having a further reduced thickness, using any of conventional methods of producing polyolefin microporous membranes such as those disclosed in the above-described JP 2002-284918 A, JP 11-179120 A, JP 2010-171003 A and JP 2010-171003 A decreasing the bubble point pore size tends to result in a higher pressure loss and an increased air resistance, making it difficult obtain a polyolefin microporous membrane having a microporous structure in which the balance between the pore size and the permeability is properly controlled.

It could therefore be helpful to provide: a polyolefin microporous membrane having an excellent capture performance capable of capturing foreign substances having a size of 10 nm or less, and excellent liquid permeability; and a method of producing the same.

### SUMMARY

We thus provide:

A polyolefin microporous membrane including at least a first layer and a second layer,

wherein the first layer is composed of a first polyolefin resin containing polyethylene,

wherein the second layer is composed of a second polyolefin resin containing polyethylene and polypropylene, and

wherein the polyolefin microporous membrane satisfies the following requirements (I) and (II):

(I) the polyolefin microporous membrane has an air resistance of from 10 to 200 sec/100 ml; and
(II) the polyolefin microporous membrane has a bubble point pore size of from 5 to 35 nm.

The ratio of the polyethylene contained in the first polyolefin resin is preferably 60% by weight or more and 100% by weight or less with respect to 100% by weight of the first polyolefin resin. The ratio of the polyethylene contained in the second polyolefin resin is preferably 1% by weight or more and 70% by weight or less, and the ratio of the polypropylene contained therein is preferably 30% by weight or more and 99% by weight or less, with respect to 100% by weight of the second polyolefin resin. Further, it is preferred that the first polyolefin resin has a composition different from the composition of the second polyolefin resin.

A filtration filter includes the above-described polyolefin microporous membrane.

A battery separator includes the above-described polyolefin microporous membrane.

The polyolefin microporous membrane exhibits an excellent liquid permeability, while having an excellent capture performance capable of capturing fine foreign substances having a size of 10 nm or less. Further, the polyolefin microporous membrane has a microporous structure with a small pore size and a highly superior air permeability, even in cases where the membrane has a reduced thickness.

### BRIEF DESCRIPTION OF THE DRAWINGS

FIG. 1 is a diagram showing the relationship between the air resistance and the bubble point pore size of polyolefin microporous membranes of Examples and Comparative Examples.

FIG. 2 is a sectional view showing a polyolefin microporous membrane according to one example.

### DETAILED DESCRIPTION

### 1. Polyolefin Microporous Membrane

The polyolefin microporous membrane includes at least a first layer composed of a first polyolefin resin and a second layer composed of a second polyolefin resin. The respective layers will be described below.

### (1) First Layer

The first layer is composed of the first polyolefin resin containing polyethylene. The first polyolefin resin preferably contains 60% by weight or more and 100% by weight or less, and more preferably 70% by weight or more and 100% by weight or less of polyethylene, with respect to the total amount of the first polyolefin resin.

The polyethylene is not particularly limited, and it is possible to use at least one selected from the group consisting of ultra-high molecular weight polyethylene (having an Mw of 1×10⁶ or more), high density polyethylene, medium density polyethylene, branched low density polyethylene and linear low density polyethylene. One type of polyethylene may be used alone, or two or more types thereof may be used in combination. The polyethylene to be used can be selected as appropriate, depending on the purpose of use.

The first polyolefin resin can contain ultra-high molecular weight polyethylene. Incorporation of ultra-high molecular weight polyethylene provides an excellent molding stability, and provides for a polyolefin microporous membrane having an excellent mechanical strength, porosity, air resistance and the like, even when the membrane has a reduced thickness. The ultra-high molecular weight polyethylene has a mass average molecular weight (Mw) of 1×10⁶ or more, preferably 1×10⁶ or more and 8×10⁶ or less, and more preferably 1.2×10⁶ or more and 3×10⁶ or less. When the Mw is within the above-described range, the polyolefin multilayer porous membrane has an improved moldability. The Mw as used herein refers to a value measured by gel permeation chromatography (GPC) to be described later.

The ultra-high molecular weight polyethylene is not particularly limited as long as it satisfies the above-described Mw, and it is possible to use one conventionally known. Further, it is possible to use not only a homopolymer of ethylene, but also an ethylene-α-olefin copolymer containing an α-olefin other than ethylene. Examples of the α-olefin other than ethylene include propylene, butene-1, pentene-1, hexene-1, 4-methylpentene-1, octene-1, vinyl acetate, methyl methacrylate, and styrene. The content of the α-olefin other than ethylene is preferably 5% by mole or less. One type of ultra-high molecular weight polyethylene can be used alone, or two or more types thereof may be used in combination. For example, two or more types of ultra-high molecular weight polyethylenes having different Mws may be used as a mixture.

The content of the ultra-high molecular weight polyethylene in the first polyolefin resin is preferably 10 to 60% by mass, more preferably 15 to 55% by mass, and still more preferably 25% by mass to 50% by mass, with respect to 100% by mass of the total amount of the first polyolefin resin. When the content of the ultra-high molecular weight polyethylene is within the above-described range, it is possible to obtain a high mechanical strength and a high porosity, even when the polyolefin microporous membrane has a reduced thickness.

Further, the first polyolefin resin can contain, as polyethylene other than the ultra-high molecular weight polyethylene, at least one selected from the group consisting of high density polyethylene, medium density polyethylene, branched low density polyethylene and linear low density polyethylene. Among them, the first polyolefin resin preferably contains high density polyethylene (having a density of 0.920 to 0.970 g/m3).

The polyethylene other than the ultra-high molecular weight polyethylene preferably has a weight average molecular weight (Mw) of 1×10⁴ or more and 1×10⁶ or less, more preferably 1×10⁵ or more and 9×10⁵ or less, and still more preferably 2×10⁵ or more and 8×10⁵ or less. When the polyethylene has an Mw within the above-described range, the resulting polyolefin microporous membrane has a good appearance, and the mean flow pore size (through pore size) of the membrane can be reduced. Further, the polyethylene other than the ultra-high molecular weight polyethylene preferably has a molecular weight distribution (Mw/Mn) of 1 or more and 20 or less, and more preferably 3 or more and 10 or less, from the viewpoint of improving extrusion moldability, and controlling physical properties by means of stable crystallization control.

As the polyethylene other than the ultra-high molecular weight polyethylene, it is possible to use not only a homopolymer of ethylene, but also an ethylene-α-olefin copolymer containing an α-olefin. Examples of the α-olefin other than ethylene include propylene, butene-1, hexene-1, pentene-1, 4-methylpentene-1, octene, vinyl acetate, methyl methacrylate and styrene. The content of the α-olefin other than ethylene is preferably 5% by mole or less. The method of producing such a copolymer is not particularly limited. However, such a polymer is preferably produced using a single-site catalyst.

The content of the polyethylene (excluding the ultra-high molecular weight polyethylene) in the first polyolefin resin is preferably 40% by mass or more and 90% by mass or less, and more preferably 45% by mass or more and less than 80% by mass, with respect to 100% by mass of the total amount of the first polyolefin resin. In particular, a good melt extrudability and an excellent uniform stretchability can be obtained, by incorporating high density polyethylene having an Mw of 2×10⁵ or more and less than 8×10⁵, in an amount within the above-described range.

Further, the first polyolefin resin can contain a resin (hereinafter, also referred to as (an) “other resin”) other than polyethylene. The other resin that can be contained in the first polyolefin resin may be, for example, a heat resistant resin or a polyolefin other than polyethylene.

The heat resistant resin may be, for example, a crystalline resin (including a resin which is partially crystalline) having a melting point of 150° C. or higher, and/or an amorphous resin having a glass transition point (Tg) of 150° C. or higher. Specific examples of the heat resistant resin include: polyesters; polymethylpentene [PMP, TPX (Transparent Polymer X), melting point: 230 to 245° C.]; polyamides (PA, melting point: 215 to 265° C.); polyarylene sulfides (PAS); fluorine-containing resins, for example, vinylidene fluoride homopolymers such as polyvinylidene fluoride (PVDF), fluorinated olefins such as polytetrafluoroethylene (PTFE), and copolymers thereof; polystyrene (PS, melting point: 230° C.); polyvinyl alcohol (PVA, melting point: 220 to 240° C.); polyimides (PI, Tg: 280° C. or higher); polyamideimides (PAI, Tg: 280° C.); polyether sulfones (PES, Tg: 223° C.); polyether ether ketones (PEEK, melting point: 334° C.); polycarbonates (PC, melting point: 220 to 240° C.); cellulose acetate (melting point: 220° C.); cellulose triacetate (melting point: 300° C.); polysulfones (Tg: 190° C.); and polyetherimide (melting point: 216° C.). The Tg as used herein refers to a value measured in accordance with JIS K7121. The heat resistant resin may be one consisting of a single resin, or may be one consisting of a plurality of resin components.

A preferred Mw of the heat resistant resin varies depending on the type of the resin. However, it is generally 1×10³ to 1×10⁶, and more preferably 1×10⁴ to 7×10⁵. The content of the other resin component(s) in the first polyolefin resin can be adjusted as appropriate as long as the desired effect is not deviated from, and the content is within the range of about 30% by mass or less with respect to 100% by mass of the total amount of the first polyolefin resin.

As the polyolefin other than polyethylene, it is possible to use, for example, at least one selected from the group consisting of: polybutene-1, polypentene-1, polyhexene-1 and polyoctene-1, having an Mw of 1×10⁴ or more and 4×10⁶ or less; and a polyethylene wax having an Mw of from 1×10³ to 1×10⁴. The content of the polyolefin other than polyethylene can be adjusted as appropriate as long as the desired effect is not impaired, and the content is preferably 20% by mass or less, more preferably 10% by mass or less, and still more preferably less than 5% by mass, with respect to 100% by mass of the total amount of the first polyolefin resin.

Further, the first polyolefin resin may contain a small amount of polypropylene as long as the desired effect is not impaired. The content of the polypropylene can be lower than the content ratio of the polypropylene contained in the second polyolefin resin to be described later. For example, the content can be adjusted to 0% by mass or more and less than 30% by mass with respect to 100% by mass of the total amount of the first polyolefin resin.

### (2) Second Layer

The second layer is composed of the second polyolefin resin containing polyethylene and polypropylene. FIG. 2 is a photograph showing one example of a cross section of the polyolefin microporous membrane observed by a scanning electron microscopy (SEM). As shown in FIG. 2, when the second polyolefin resin contains polypropylene, the pore size of the second layer can be reduced as compared to that of the first layer. The size of the pore size of each layer can be confirmed by observing a cross section of the polyolefin microporous membrane by a scanning electron microscopy (SEM).

The polypropylene is not particularly limited, and it is possible to use a propylene homopolymer, a copolymer of propylene with another α-olefin and/or diolefin (propylene copolymer), or a mixture thereof. Among them, it is preferred to use a propylene homopolymer, from the viewpoint of improving the mechanical strength, reducing the through pore size and the like.

As the propylene copolymer, either a random copolymer or a block copolymer can be used. The α-olefin in the propylene copolymer is preferably an α-olefin having 8 or less carbon atoms. Examples of the α-olefin having 8 or less carbon atoms include ethylene, butene-1, pentene-1, 4-methylpentene-1, octene-1, vinyl acetate, methyl methacrylate and styrene; and any combination of these. The diolefin in the propylene copolymer is preferably a diolefin having from 4 to 14 carbon atoms. Examples of the diolefin having from 4 to 14 carbon atoms include butadiene, 1,5-hexadiene, 1,7-octadiene and 1,9-decadiene. The content of the other α-olefin or diolefin in the propylene copolymer is preferably less than 10% by mole, with respect to 100% by mole of the propylene copolymer.

The polypropylene preferably has a weight average molecular weight (Mw) of 1×10⁵ or more, more preferably 2×10⁵ or more, and particularly preferably 5×10⁵ or more and 4×10⁶ or less. When the polypropylene has an Mw within the above-described range, the resulting polyolefin microporous membrane has a good strength and air resistance. Further, the polyolefin microporous membrane exhibits an excellent meltdown property when used as a separator for a secondary battery. The content of polypropylene having an Mw of 5×10⁴ or less is preferably 5% by mass or less with respect to 100% by mass of the polypropylene contained in the second layer.

The polypropylene preferably has a molecular weight distribution (Mw/Mn) of 1.01 to 100, more preferably 1.1 to 50, and still more preferably 2.0 to 20. This is because, when the polypropylene has a molecular weight distribution within the above-described range, the strength, air resistance and meltdown property of the resulting polyolefin microporous membrane will be improved. The Mw, the Mw/Mn and the like as used herein refer to values as measured by the GPC method to be described later.

The polypropylene preferably has a melting point of 155 to 175° C., and more preferably 160° C. to 175° C., from the viewpoint of improving the meltdown property. Further, the polypropylene preferably has a heat of fusion ΔHₘ of 90 J/g or more, and more preferably 100 J/g or more, from the viewpoint of improving the meltdown property and the permeability. When the polypropylene has a melting point and a heat of fusion within the above-described ranges, the microporous structure and the air resistance of the resulting polyolefin microporous membrane will be improved. Further, the polyolefin microporous membrane exhibits an excellent meltdown property when used as a separator for a secondary battery. The melting point and the heat of fusion as used herein refer to values as measured in accordance with JIS K7121, using a differential scanning calorimeter (DSC).

The content of the polypropylene in the second polyolefin resin is preferably 20% by mass or more and 80% by mass or less, more preferably 25% by mass or more and 70% by mass or less, and still more preferably 31% by mass or more and 65% by mass or less, with respect to 100% by mass of the total amount of the second polyolefin resin.

Further, the content of the polypropylene in the polyolefin porous membrane is preferably 2.0% by mass or more and less than 15%, more preferably 2.5% by mass or more and less than 12% by mass, and still more preferably 3.0% by mass or more and 11% by mass or less, with respect to 100% by mass of the total amount of the first and the second polyolefin resins contained in the polyolefin microporous membrane. When the content of the polypropylene is 2.0% by mass or more with respect to 100% by mass of the total amount of the first and the second polyolefin resins, the resulting polyolefin microporous membrane has a uniform and fine microporous structure, and is capable of exhibiting a capture performance. Further, the polyolefin microporous membrane exhibits a markedly improved heat resistance and an excellent meltdown property when used as a battery separator. When the content of the polypropylene is less than 15%, the resulting polyolefin microporous membrane has a high porosity and an excellent strength, and at the same time, it is possible to prevent an excessive decrease in the bubble point pore size, and thus, the occurrence of pressure loss.

The polyethylene to be contained in the second polyolefin resin may be the same as, or different from, the polyethylene contained in the first polyolefin resin. The polyethylene to be contained in the second polyolefin resin may be selected as appropriate, depending on the desired physical properties. In particular, it is preferred that the second polyolefin resin preferably contains polyethylene other than ultra-high molecular weight polyethylene, and more preferably contains high density polyethylene. The blending of the above-described polypropylene with high density polyethylene facilitates the melt extrusion of the resulting mixture. Examples of such polyethylene include the same polyethylenes as those exemplified for the first polyolefin resin.

The content of the polyethylene in the second polyolefin resin is preferably 20% by mass or more and 80% by mass or less, and more preferably 30% by mass or more and less than 75% by mass, with respect to 100% by mass of the total amount of the second polyolefin resin. In particular, a good melt extrudability and an excellent uniform stretchability can be obtained, by incorporating high density polyethylene having an Mw of 2×10⁵ or more and less than 8×10⁵, in an amount within the above-described range.

Further, the second polyolefin resin can contain ultra-high molecular weight polyethylene, as long as the desired effect is not impaired. When the second polyolefin resin contains ultra-high molecular weight polyethylene, the content thereof is, for example, 0% by mass or more and 30% by mass or less, preferably 0% by mass or more and 15% by mass or less, more preferably 0% by mass or more and 10% by mass or less, and may be 0% by mass, with respect to 100% by mass of the total amount of the second polyolefin resin.

Further, the second polyolefin resin can contain another resin component, if necessary, as with the first polyolefin resin. Specifically, as the other resin component, it is possible to use any of the same components as the other resin components described for the first polyolefin resin.

### (3) First Layer and Second Layer

The polyolefin microporous membrane includes at least the first layer and the second layer. Further, the polyolefin microporous membrane can have a layer structure composed of at least three layers, in which structure the first layer, the second layer and the first layer, or the second layer, the first layer and the second layer, are laminated in the order mentioned. When the polyolefin microporous membrane includes a plurality of the first layers or the second layers, the compositions of the first layers or the second layers may be the same as, or different from, each other. Still further, the polyolefin microporous membrane can include another layer other than the first and the second microporous layers, if necessary, so that the membrane has a layer structure composed of three or more layers.

For example, when the first layer, the second layer and the first layer are laminated in this order, the first layers containing polyethylene are provided on both surfaces of the second layer containing propylene. This arrangement provides for preventing the detachment and breakage of the second layer during the production process or when used as a filtration filter, a separator or the like, and enables to protect the second layer having a smaller pore size.

The thickness of each of the layers in the polyolefin microporous membrane is not particularly limited. However, the ratio (mass ratio in solid content) of the first layer to the second layer is preferably 90/10 to 10/90, and more preferably 80/20 to 20/80. When the mass ratio is controlled within the above-described range, the resulting polyolefin microporous membrane can exhibit both an excellent liquid permeability and capture performance in a balanced manner

### (4) Respective Properties

In the polyolefin microporous membrane, the pore size of the second layer can be made smaller than the pore size of the first layer, by adjusting the content of the polypropylene in the second polyolefin resin and the like, as appropriate. Further, the production method to be described later enables to further improve the air resistance and the like of the polyolefin microporous membrane, while maintaining a small pore size to a certain extent. The respective properties of the polyolefin microporous membrane will be described below.

### (I) Air Resistance

The polyolefin microporous membrane has an air resistance of 10 sec/100 cm³ or more and 200 sec/100 cm³ or less, preferably 30 sec/100 cm³ or more and 180 sec/100 cm³ or less, more preferably 50 sec/100 cm³ or more and 170 sec/100 cm³ or less. When the air resistance is within the above-described range, a highly superior fluid permeability can be obtained in cases where the polyolefin microporous membrane is used as a filter. An air resistance of 200 sec/100 cm3 or more causes an increase in the pressure loss, thereby deteriorating the water permeability. When the polyolefin microporous membrane is used as a battery separator, an excellent ion permeability can be obtained, leading to a low impedance and an improved battery output. The air resistance can be controlled within the above-described range, by adjusting the content of the polypropylene, stretching conditions, the temperature for carrying out a heat setting treatment of a gel-like sheet after being stretched and the like. The air resistance as used herein refers to a value measured by the method described in Examples to be described later.

### (II) Bubble Point (BP) Pore Size

The polyolefin microporous membrane has a bubble point (BP) pore size (maximum pore size), as measured using Perm porometer in the order of Dry-up and Wet-up, of 5 nm or more and 35 nm or less, preferably 10 nm or more and 33 nm or less, and more preferably 15 nm or more and 30 nm or less. When the BP pore size is controlled within the above-described range, the polyolefin microporous membrane has a capture performance of capturing substances having a size of 10 nm or less, and a highly superior air permeability. The BP pore size can be controlled within the above-described range, by adjusting the polypropylene contents in the first and the second polyolefin resins within the above-described ranges, and controlling treatment conditions for the heat setting step and the like of a gel-like multilayer sheet to be described later, as appropriate. The BP pore size as used herein refers to a value measured by the method described in Examples to be described later.

### (III) Mean Flow Pore Size

The polyolefin microporous membrane preferably has a mean flow pore size (pore size of through pores within the membrane), as measured using Perm porometer in the order of Dry-up and Wet-up, of 1 nm or more and 30 nm or less, more preferably 5 nm or more and 25 nm or less, and still more preferably 10 nm or more and 22 nm or less. The mean flow pore size can be controlled within the above-described range, by adjusting the polypropylene contents in the first and the second polyolefin resins within the above-described ranges, and controlling treatment conditions for the heat setting step and the like of the gel-like multilayer sheet to be described later, as appropriate. The mean flow pore size as used herein refers to a value measured by the method described in Examples to be described later. Further, the ratio (BP pore size/mean flow pore size) of the BP pore size (maximum pore size) relative to the above-described mean flow pore size is preferably 1.0 to 1.7, and more preferably 1.0 to 1.6. When the ratio is within the above-described range, the polyolefin microporous membrane has a structure having more uniform pores (through pores).

### (IV) Porosity

The polyolefin microporous membrane has a porosity of preferably 43% or more, and more preferably 48% or more and 70% or less. In general, the physical properties such as membrane thickness and strength, of the polyolefin microporous membrane are controlled by stretching the membrane. However, when a polyolefin microporous membrane having a reduced thickness of less than 20 μm is stretched at a high draw ratio, for example, it may be difficult to achieve both a reduced thickness and a high porosity. One of the reasons for this is thought to be the tendency that pores are more likely to be collapsed due to stretching, when the thickness of the membrane is further reduced. Accordingly, in the polyolefin microporous membrane, the porosity is controlled within the above-described range by adjusting the contents of the resin components in the respective layers, and carrying out the heat setting step and the like of the gel-like multilayer sheet to be described later, thereby achieving both a reduced thickness and a high porosity at a high level. The porosity as used herein refers to a value measured by the method described in Examples to be described later.

### (V) Membrane Thickness

The polyolefin microporous membrane preferably has a membrane thickness of 1 μm or more and 25 μm or less, more preferably 2 μm or more and 20 μm or less, still more preferably 3 μm or more and 18 μm or less, and further still more preferably 4 μm or more and 16 μm or less. The membrane thickness can be controlled within the above-described range, for example, by adjusting the amount of discharge from a T die, the rotational velocity of a chill roll, line speed, draw ratio and the like, as appropriate. When the polyolefin microporous membrane has a membrane thickness within the above-described range, and when the membrane is used as a filtration filter, a good balance between the strength and the liquid permeability can be achieved, and a larger filtration area is more easily obtained due to having a smaller membrane thickness. Further, when the polyolefin microporous membrane is used as a battery separator, the battery capacity can be improved.

### 2. Method of Producing Polyolefin Microporous Membrane

The method of producing the polyolefin microporous membrane preferably includes the following steps (1) to (7):

(1) the step of melt-blending the first polyolefin resin and a membrane-forming solvent to prepare a first polyolefin solution;
(2) the step of melt-blending the second polyolefin resin and a membrane-forming solvent to prepare a second polyolefin solution;
(3) the step of coextruding the first and the second polyolefin solutions, and cooling the resulting extruded molding to form a gel-like multilayer sheet;
(4) a first stretching step of stretching the gel-like multilayer sheet;
(5) the step of heat setting the gel-like multilayer sheet after stretching, at a temperature which is the same as or higher than the temperature in the stretching step;
(6) the step of removing the membrane-forming solvent from the gel-like multilayer sheet after heat setting, to obtain a multilayer sheet; and
(7) the step of drying the multilayer sheet.

In the above-described steps (1) to (4), (6) and (7), conventionally known methods can be used. For example, it is possible to use the methods described in JP 2132327 B and JP 3347835 B, WO 2006/137540 and the like. Production conditions for the respective steps can be adjusted as appropriate, depending on the composition of the resins to be used and the like.

In the production method, when the above-described resin materials are used in the step (1) and the step (2), and when the gel-like multilayer sheet after stretching is subjected to heat setting at a temperature which is the same as or higher than the temperature in the stretching step, in the step (3), it is possible to easily produce a polyolefin microporous membrane which has an excellent air resistance and porosity even in cases where the membrane has a reduced thickness, and which has a small maximum pore size.

The production method can further include the following steps (8) to (10):

(8) a second stretching step of stretching the multilayer sheet after drying;
(9) the step of heat treating the multilayer sheet after drying; and
(10) the step of subjecting the multilayer sheet after the stretching step to a crosslinking treatment and/or a hydrophilization treatment.

By carrying out stretching under appropriate temperature conditions in the step (4) and the step (8), it is possible to obtain a good porosity and to achieve the control of the microporous structure, even when the polyolefin microporous membrane has a reduced thickness. The respective steps will now be described individually.

### Steps (1) and (2): Preparation Steps of First and Second Polyolefin Solutions

To each of the first polyolefin resin and the second polyolefin resin, an appropriate membrane-forming solvent is added separately, followed by melt-blending to prepare each of the first and the second polyolefin solutions. The melt-blending can be carried out using a conventionally known method. For example, it is possible to use a method using a twin screw extruder such as those described in JP 2132327 B and JP 3347835 B.

In the first and second polyolefin solutions, the blending ratio of the first polyolefin resin or the second polyolefin resin and the membrane-forming solvent is not particularly limited. However, it is preferred that 65 to 80 parts by mass of the membrane-forming solvent be blended, with 20 to 35 parts by mass of the first polyolefin resin or the second polyolefin resin. When the ratio of the first or the second polyolefin resin is within the above-described range, the occurrence of swelling and neck-in at the exit of a die can be prevented during the extrusion of the first or the second polyolefin solution, as a result of which the moldability and self-supportability of the resulting extruded molding (gel-like molding) can be improved.

### Step (3): Step of Forming Gel-Like Multilayer Sheet

The first and the second polyolefin solutions are supplied from the respective extruders to one die, where both the solutions are arranged in layers and extruded in the form of a sheet.

The extrusion may be carried out either by a flat die method or an inflation method. In either method, it is possible to use: a method in which the respective solutions are supplied to separate manifolds, and laminated in layers at the lip entrance of a multilayer die (multiple manifold method); or a method in which the flows of the respective solutions are arranged in layers before being supplied to a die (block method). Since the multiple manifold method and the block method themselves are well known, detailed descriptions thereof will be omitted. The gap of the multilayer flat die is 0.1 to 5 mm. The extrusion is preferably carried out at a temperature of 140 to 250° C., and at a speed of 0.2 to 15 m/min. The ratio of the membrane thicknesses of the first and the second microporous layers can be controlled by adjusting the extrusion amounts of the first and the second polyolefin solutions. The extrusion can be carried out, for example, using any of the methods disclosed in JP 2132327 B and JP 3347835 B.

The resulting laminated extruded molding is then cooled to obtain a gel-like multilayer sheet. The gel-like multilayer sheet can be formed, for example, using any of the methods disclosed in JP 2132327 B and JP 3347835 B. The cooling is preferably carried out at a cooling rate of 50° C./min or more, at least until the gelation temperature is reached. The cooling is preferably carried out until the laminated extruded molding is cooled to 35° C. or lower. By cooling the laminated extruded molding, the microphases of the first and the second polyolefins separated by the membrane-forming solvent can be fixed. When the cooling rate is within the above-described range, the degree of crystallinity can be maintained within a moderate range, and a gel-like multilayer sheet suitable for stretching can be obtained. The cooling can be carried out by a method of bringing the extruded molding into contact with a coolant such as cold blast or cooling water, a method of bringing the extruded molding into contact with a chill roll or the like. However, the cooling is preferably carried out by bringing the extruded molding into contact with a roll cooled with a coolant.

### Step (4): First Stretching Step

Next, the resulting gel-like multilayer sheet is stretched at least uniaxially (first stretching). The gel-like multilayer sheet can be stretched uniformly due to containing the membrane-forming solvent. The gel-like multilayer sheet is preferably stretched at a predetermined draw ratio, after being heated, by a tenter method, a roll method, an inflation method, or any combination thereof. The stretching may be uniaxial stretching or biaxial stretching, but biaxial stretching is preferred. In biaxial stretching, any of simultaneous biaxial stretching, stepwise stretching and multistage stretching (for example, a combination of simultaneous biaxial stretching and stepwise stretching) may be performed.

The draw ratio (areal draw ratio) in this step, in uniaxial stretching, is preferably two times or more, and more preferably 3 to 30 times. In biaxial stretching, the draw ratio is preferably 9 times or more, more preferably 16 times or more, and particularly preferably 25 times or more. Further, the draw ratios in the longitudinal (or machine) direction and the transverse direction (MD and TD direction) are each preferably 3 times or more, and the draw ratios in the MD direction and the TD direction may be the same as, or different from, each other. When the draw ratio is adjusted to 9 times or more, an improvement in pin puncture strength can be expected. The draw ratio as used in this step refers to the areal draw ratio of the microporous membrane immediately before being subjected to the next step, relative to the microporous membrane immediately before being subjected to this step. Further, it is more preferred that the relationship(s) represented by any one or more of the above-described equations 2 to 5 be satisfied, within the above-described ranges of the draw ratio.

The stretching temperature in this step is preferably controlled within the range of from the crystal dispersion temperature (Tcd) of the second polyolefin resin to the Tcd+30° C., more preferably within the range of from the crystal dispersion temperature (Tcd)+5° C. to the crystal dispersion temperature (Tcd)+28° C., and particularly preferably within the range of from the Tcd+10° C. to the Tcd+26° C. When the stretching temperature is within the above-described range, membrane rupture due to the stretching of the second polyolefin resin is prevented, thereby allowing for stretching at a high draw ratio.

The crystal dispersion temperature (Tcd) is determined by measuring the temperature characteristics of dynamic viscoelasticity in accordance with ASTM D4065. The stretching temperature is preferably adjusted to a temperature of 90° C. to 130° C., more preferably 110° C. to 120° C., and still more preferably 114° C. to 117° C. since the ultra-high molecular weight polyethylene, the polyethylene other than the ultra-high molecular weight polyethylene and the polyethylene compositions have a crystal dispersion temperature of about 90° C. to 100° C.

The stretching as described above causes cleavage between polyethylene lamellae, resulting in the refinement of the polyethylene phase and the formation of a number of fibrils. The fibrils are connected irregularly and three-dimensionally to form a network structure. Thus, the stretching improves the mechanical strength and enlarges the pores of the gel-like multilayer sheet. However, by carrying out the stretching under appropriate conditions, it becomes possible to control the through pore size, and to produce a polyolefin microporous membrane having a high porosity, even when the thickness of the membrane is further reduced.

Depending on the desired physical properties, the gel-like multilayer sheet may be stretched with a temperature distribution provided in the direction of membrane thickness. This provides for a microporous membrane having a further improved mechanical strength. The method therefor can be found in JP 3347854 B.

### Step (5): Heat Setting

Next, the resulting stretching film is subjected to a heat setting treatment. The heat setting treatment refers to a heat treatment in which heating is carried out such that the size of the membrane is kept unchanged. The heat setting treatment is preferably carried out by a tenter method.

In this step, it is preferred that the gel-like multilayer sheet after stretching be subjected to heat setting at a temperature which is the same as or higher than the stretching temperature in the first stretching step, more preferably at a temperature 1 to 25° C. higher, and still more preferably at a temperature 3 to 20° C. higher than the stretching temperature in the first stretching step. This allows for increasing the amount of permeated water through the microporous membrane, and improving the liquid permeability. The heat setting is carried out for a period of time of about 10 to 20 seconds.

### Step (6): Removal of Membrane-forming Solvent

After the completion of heat setting, a washing solvent is used to carry out the removal (cleaning) of the membrane-forming solvent. Since the first and the second polyolefin phases are separated from the membrane-forming solvent phase, the removal of the membrane-forming solvent provides for a porous membrane which is composed of fibrils forming a fine three-dimensional network structure, and which includes pores (voids) communicating three-dimensionally and irregularly. For example, it is possible to use any of the methods disclosed in JP 2132327 B and JP 2002-256099 A.

### Step (7): Drying

The microporous membrane after the removal of the membrane-forming solvent is dried by heat-drying or air-drying. The drying temperature is preferably equal to or lower than the crystal dispersion temperature (Tcd) of the second polyolefin resin, and particularly preferably 5° C. or more lower than the Tcd. The drying is preferably carried out until the residual amount of the washing solvent is reduced to 5% by mass or less, and more preferably 3% by mass or less, with respect to 100% by mass (dry weight) of the microporous membrane. When the residual amount of the washing solvent is within the above-described range, the porosity of the microporous membrane is maintained in cases where the latter-stage stretching step and the heat treatment step are carried out, and the deterioration of the permeability can be prevented.

### Step (8): Second Stretching Step

The microporous membrane after drying may further be stretched at least uniaxially. The stretching of the microporous membrane can be carried out by a tenter method or the like in the same manner as described above, while heating the membrane. The stretching may be uniaxial stretching or biaxial stretching. In biaxial stretching, either simultaneous biaxial stretching or stepwise stretching may be performed, but simultaneous biaxial stretching is preferred. The stretching temperature in this step is usually 90 to 135° C., and more preferably 95 to 130° C., but not particularly limited thereto.

When carrying out the stretching of the microporous membrane in the uniaxial direction, in this step, the lower limit of the draw ratio (areal draw ratio) is preferably 1.0 times or more, more preferably 1.1 times or more, and still more preferably 1.2 times or more. The upper limit thereof is preferably 1.8 times or less. In uniaxial stretching, the draw ratio in the MD direction or the TD direction is 1.0 to 2.0 times. In biaxial stretching, the lower limit of the areal draw ratio is preferably 1.0 times or more, more preferably 1.1 times or more, and still more preferably 1.2 times or more. The upper limit thereof is suitably 3.5 times or less. The draw ratios in the MD direction and the TD direction are each 1.0 to 2.0 times, and the draw ratios in the MD direction and the TD direction may be the same as, or different from, each other. The draw ratio as used in this step refers to the draw ratio of the microporous membrane immediately before being subjected to the next step, relative to the microporous membrane immediately before being subjected to this step.

### Step (9): Heat Treatment

The microporous membrane after drying can be subjected to a heat treatment. The heat treatment stabilizes crystals and makes lamellae uniform. The heat treatment can be carried out by a heat setting treatment and/or a heat relaxation treatment. The heat setting treatment refers to a heat treatment in which heating is carried out such that the size of the membrane is kept unchanged. The heat relaxation treatment refers to a heat treatment in which the membrane is heat-shrunk in the MD direction and/or the TD direction, during the heating. The heat setting treatment is preferably carried out by a tenter method or a roll method. For example, the heat relaxation treatment can be carried out by the method disclosed in JP 2002-256099 A. The heat treatment is preferably carried out at a temperature within the range of from the Tcd to the Tm of the second polyolefin resin, more preferably within the range of the stretching temperature of the microporous membrane ±5° C., and particularly preferably within the range of the second stretching temperature of the microporous membrane ±3° C.

### Step (10): Cross-Linking Treatment and Hydrophilization Treatment

The microporous membrane after bonding or stretching can further be subjected to a crosslinking treatment and a hydrophilization treatment. For example, the crosslinking treatment is carried out by irradiating ionizing radiation such as alpha-rays, beta-rays, gamma-rays, electron beams and the like, to the microporous membrane. In electron beam irradiation, the electron beam is preferably irradiated with an electron dose of 0.1 to 100 Mrad, at an acceleration voltage of 100 to 300 kV. The crosslinking treatment increases the meltdown temperature of the microporous membrane. Further, the hydrophilization treatment can be carried out by monomer grafting, a surfactant treatment, corona discharge or the like. The monomer grafting is preferably carried out after the crosslinking treatment.

### 4. Filtration Filter

The above-described polyolefin microporous membrane can be used as a filter for filtration. In particular, the polyolefin microporous membrane can be suitably used as a filter for microfiltration, since the microporous membrane has a highly superior fluid permeability despite having a small pore size.

When the polyolefin microporous membrane is used as a filtration filter, the membrane is preferably arranged such that the first layer is located on the upstream side, and the second layer is located on the downstream side, relative to the flow of the fluid to be filtered. This arrangement provides for capturing relatively large foreign substances with the first layer having a larger pore size, and then capturing fine foreign substances with the second layer having a smaller pore size. In this manner, the microporous membrane exhibits an excellent filtration efficiency and filter life without having to laminate a nonwoven fabric or the like to the polyolefin microporous membrane, as has been conventionally done. An increase in filtration flow rate can also be achieved since the polyolefin microporous membrane has an excellent fluid permeability.

Further, when the polyolefin microporous membrane is used as a filtration filter, the membrane can be configured to have a structure composed of at least three layers, in which the first layer, the second layer, and the first layer are laminated in this order. In this example, the polyolefin microporous membrane has an excellent filtration efficiency, filter life, filtration flow rate and the like, as described above. At the same time, the configuration in which the first layer containing polyethylene is formed on both surfaces of the second layer containing propylene prevents the detachment and breakage of the second layer during the production process or when used as a filtration filter, and enables protection of the second layer having a smaller pore size.

Still further, when the polyolefin microporous membrane is used as a filtration filter, the fact that the microporous membrane has a small thickness serves to increase the filtration area. This is because, when it is assumed that a filter cartridge of the same size is used, the use of a filter medium with a smaller thickness leads to in an increased area of the filter medium. Moreover, when separate films are bonded by thermal fusion bonding, the pores are collapsed to deteriorate the permeability. However, in the polyolefin microporous membrane, the first layer and the second layer are intertwined at the interface therebetween, due to being integrally molded, and the layers having different pore sizes can be integrated without delamination and while maintaining the pores.

The fluid to be filtered by the filtration filter is not particularly limited, and examples thereof include process liquids used in the production of highly integrated semiconductors such as photoresists; developers; thinners; and inorganic chemicals. In particular, the polyolefin microporous membrane can be suitably used as a filtration filter for a process liquid used in the production of highly integrated semiconductors, which filter is required to capture substances having a size of 10 nm or less.

It is also possible to provide another layer(s) other than the first layer and the second layer, when used as the filtration filter. For example, a nonwoven fabric can be arranged on the upstream side and/or the downstream side of the polyolefin microporous membrane relative to the flow of the fluid to be filtered.

### 5. Battery Separator

The polyolefin microporous membrane can also be used as a battery separator, and can be suitably used either in a battery using an aqueous electrolytic solution, or in a battery using a nonaqueous electrolyte. Specifically, the polyolefin microporous membrane can be preferably used as a separator for a secondary battery such as a nickel-hydrogen battery, a nickel-cadmium battery, a nickel-zinc battery, a silver-zinc battery, a lithium secondary battery or a lithium polymer secondary battery. In particular, the polyolefin microporous membrane is preferably used as a separator for a lithium ion secondary battery.

The polyolefin microporous membrane improves the permeability of the electrolytic solution and prevents the growth of dendrites when used as a battery separator since the second layer has a small pore size, even though the separator has a low air resistance.

It is also possible to provide another layer(s) other than the microporous layers including the first layer and second layer to form a laminated porous membrane. The other layer may be, for example, a porous layer formed using a filler-containing resin solution containing a filler and a resin binder, or a heat resistant resin solution.

The filler may be, for example, an inorganic filler or an organic filler such as a crosslinked polymer filler, and is preferably one which has a melting point of 200° C. or higher and a high electrical insulation, and which is electrochemically stable in the usage range of a lithium ion secondary battery. Examples of such an inorganic filler include: oxide-based ceramics such as alumina, silica, titania, zirconia, magnesia, ceria, yttria, zinc oxide and iron oxide; nitride-based ceramics such as silicon nitride, titanium nitride and boron nitride; ceramics such as silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth and silica sand; glass fibers; and fluorinated products thereof. Examples of such an organic filler include: crosslinked polystyrene particles; crosslinked acrylic resin particles; crosslinked methyl methacrylate particles; and fluorine resin particles such as PTFE particles. One type of these fillers may be used alone, or two or more types thereof may be used in combination. The average particle size of the filler is not particularly limited. For example, the filler preferably has an average particle size of 0.1 μm or more and 3.0 μm or less. The ratio (mass fraction) of the filler in the porous layer is preferably 50% or more and 99.99% or less, from the viewpoint of improving the heat resistance.

As the resin binder, it is possible to suitably use any of the polyolefins and heat resistant resins described in the section of the other resin component to be contained in the aforementioned first polyolefin resin. The ratio of the resin binder with respect to the total amount of the filler and the resin binder, in volume fraction, is preferably 0.5% or more and 8% or less, from the viewpoint of improving the binding properties between the filler and the resin binder. Further, as the heat resistant resin, it is possible to suitably use any of the same heat resistant resins as described in the section of the first polyolefin resin.

The method of coating the filler-containing resin solution or the heat resistant resin solution on the surface(s) of the polyolefin microporous membrane is not particularly limited, as long as the method allows for achieving the required layer thickness and coating area. Specific examples of the coating method include a gravure coater method, a small-diameter gravure coater method, a reverse roll coater method, a transfer roll coater method, a kiss coater method, a dip coater method, a knife coater method, an air doctor coater method, a blade coater method, a rod coater method, a squeeze coater method, a cast coater method, a die coater method, a screen printing method and a spray coating method.

The solvent to be used in the filler-containing solution or the heat resistant resin solution is not particularly limited, and it is possible to use any known solvent which can be removed from the solution coated on the polyolefin microporous membrane. Specific examples of the solvent include N-methylpyrrolidone, N,N-dimethylformamide, N,N-dimethylacetamide, water, ethanol, toluene, hot xylene, methylene chloride and hexane.

The method of removing the solvent is not particularly limited, and any known method can be used as long as the method does not adversely affect the polyolefin microporous membrane. Specific examples of the removal method include: a method of drying the polyolefin microporous membrane at a temperature equal to or less than the melting point thereof, while fixing the membrane; a method of drying the polyolefin microporous membrane under reduced pressure; and a method in which the polyolefin microporous membrane is dipped in a poor solvent of the resin binder or the heat resistant resin to extract the solvent while solidifying the resin.

The above-described porous layer preferably has a thickness of 0.5 μm or more and 100 μm or less, from the viewpoint of improving the heat at resistance. In the laminated porous membrane, the ratio of the thickness of the porous layer with respect to the thickness of the laminated porous membrane can be adjusted as appropriate, depending on the purpose of use. Specifically, for example, the thickness of the porous layer is preferably 15% or more and 80% or less, and more preferably 20% or more and 75% or less, with respect to 100% of the total thickness of the laminated porous membrane. Further, the porous layer may be formed on one surface of the polyolefin microporous membrane, or on both surfaces thereof.

In a lithium ion secondary battery, a cathode and an anode are laminated with a separator interposed therebetween, and the separator contains an electrolytic solution (electrolyte). The structure of the electrodes is not particularly limited, and any of conventionally known structures can be used. For example, it is possible to employ: an electrode structure in which a disk-like cathode and anode are arranged to face each other (coin type); an electrode structure in which plate-like cathodes and anodes are laminated alternately (laminate type); an electrode structure in which a belt-like cathode and anode are laminated and wound (wound type); or the like.

The current collector, cathode, positive active material, anode, negative active material and electrolytic solution to be used in a lithium ion secondary battery are not particularly limited, and conventionally known materials can be used in combination, as appropriate.

This disclosure is not limited to the above-described examples, and various modifications can be made within the scope of the appended claims.

### EXAMPLES

Our membranes and methods will now be described in further detail, with reference to Examples. However, the examples are in no way limited to these Examples.

Respective evaluation methods and analysis methods as well as materials used in Examples are as follows.

### 1. Evaluation Methods and Analysis Methods

### (1) Membrane Thickness (μm)

Ten test pieces each having a length in the longitudinal direction of 5 cm and a length in the width direction of 5 cm were cut out at random from the polyolefin microporous membrane, and the thickness of the center of each test piece was measured. The mean value of the measured values of all the ten test pieces was defined as the thickness of the polyolefin microporous membrane.

Litematic VL-50A, manufactured by Mitutoyo Corporation, was used as an apparatus for measuring the thickness.

### (2) Porosity (%)

The porosity was determined according to the following equation comparing: the weight w₁ of the polyolefin microporous membrane; and the weight w₂ of a non-porous polymer which is equivalent to the polyolefin microporous membrane (namely, a polymer having the same width, length and composition).

Porosity (%)=(w₂−w₁)/w₂×100

(3) Air Resistance (sec/100 cm³)

Using a digital Oken-type air permeability tester, EGO1, manufactured by Asahi Seiko Co., Ltd., the air resistance of the polyolefin microporous membrane was measured in accordance with JIS P-8117 (2009), while fixing the membrane such that no wrinkles were formed at the portion to be measured. Samples each having a size of 5 cm square were prepared and the air resistance was measured at one point, at the center of each sample, and the measured value was defined as the air resistance [sec] of the sample. The measurement was carried out for ten test pieces collected at random from the polyolefin microporous membrane, and the mean value of the measured values of the ten test pieces was defined as the air resistance (sec/100 ml) of the polyolefin microporous membrane.

### (4) Bubble Point Pore Size and Mean Flow Pore Size (nm)

Using Perm porometer (brand name, Model: CFP-1500A) manufactured by Porous Materials, Inc., the bubble point pore size was measured in the order of Dry-up and Wet-up. In the Wet-up measurement, a pressure was applied to the microporous membrane which had been sufficiently immersed in Galwick (brand name) having a known surface tension, and the pore size of the membrane, calculated from the pressure at which air started to pass through the membrane, was defined as the bubble point pore size (maximum pore size). The mean flow pore size was calculated from the pressure at the point of intersection of a curve having half the slope of the pressure-flow rate curve obtained in the Dry-up measurement, and the curve obtained in the Wet-up measurement. The following equation was used to calculate the pore size from the pressure.

d=C·γ/P

In the equation, “d (μm)” represents the pore size of the microporous membrane, “γ (mN/m)” represents the surface tension of a liquid, “P (Pa)” represents the pressure, “C” represents a constant. The measurement was carried out for five test pieces collected at random from the polyolefin microporous membrane, and the respective mean values of the measured values of the five test pieces were defined as the bubble point pore size and the mean flow pore size of the polyolefin microporous membrane.

(5) Water Permeability (ml/min·cm²)

The polyolefin microporous membrane was set in a stainless steel permeation cell having a diameter of 39 mm. After moistening the thus set polyolefin microporous membrane with a small amount (0.5 ml) of ethanol, 100 ml of pure water was introduced into the permeation cell, and the pure water was filtered at a differential pressure of 90 kPa. From the amount of permeated water (cm³) 10 minutes after the start of filtration, the water permeability per unit hour (min) and unit area (cm²) was determined. The measurement was carried out for five test pieces collected at random from the polyolefin microporous membrane, and the mean value of the measured values of the five test pieces was defined as the amount of permeated water of the polyolefin microporous membrane.

(6) Weight Average Molecular Weight (Mw) The Mws of UHMWPE and HDPE were determined by gel permeation chromatography (GPC) under the following conditions.
Measuring apparatus: GPC-150C, manufactured by Waters Corporation
Column: Shodex UT806M, manufactured by Showa Denko K.K.
Column temperature: 135° C.
Solvent (mobile phase): o-dichlorobenzene
Solvent flow rate: 1.0 ml/min
Sample concentration: 0.1 wt % (dissolution conditions: 135° C./1 h)
Injection amount: 500 μl
Detector: a differential refractometer (RI detector), manufactured by Waters Corporation Calibration curve: prepared from a calibration curve obtained using a monodisperse polystyrene standard sample, using a predetermined conversion constant

### (7) Melting Point

The heat of fusion ΔHₘ was measured in accordance with JIS K7122, by the following procedure. Specifically, a sample was placed in a sample holder of a differential scanning calorimeter (DSC-System 7, manufactured by Perkin Elmer, Inc.), and subjected to a heat treatment at 190° C. for 10 minutes, under a nitrogen atmosphere. Thereafter, the sample was cooled to 40° C. at a rate of 10° C./min, maintained at 40° C. for 2 minutes, and then heated to 190° C. at a rate of 10° C./min. A straight line passing through a point at 85° C. and a point at 175° C. on the DSC curve (melting curve) obtained in the heating process, was drawn as the base line. Then the amount of heat (unit: J) was calculated from the area of the portion surrounded by the base line and the DSC curve, and the thus calculated amount of heat was divided by the weight of the sample (unit: g), to obtain the heat of fusion ΔHₘ (unit: J/g). In the same manner as the heat of fusion ΔHₘ, the temperature at the minimum value in the endothermic melting curve was determined as the melting point.

### 2. Examples and Comparative Examples

### Example 1

### (1) Preparation of First Polyolefin Solution

To 100 parts by mass of a first polyolefin resin composed of 40% by mass of ultra-high molecular weight polyethylene (UHPE) having an Mw of 2.0×10⁶, and 60% by mass of high density polyethylene (HDPE; density: 0.955 g/cm³, melting point: 135° C.) having an Mw of 5.6×10⁵, 0.2 parts by mass of tetrakis[methylene-3-(3,5-ditertiarybutyl-4-hydroxyphenyl)-propionate]methane, as an antioxidant, was blended, to prepare a mixture. Into a strong-blending twin screw extruder, 25 parts by mass of the resulting mixture was introduced, and 75 parts by mass of liquid paraffin [35 cSt (40° C.)] was supplied via a side feeder of the twin screw extruder, followed by melt-blending the resultant under the conditions of 230° C. and 250 rpm, to prepare a first polyolefin solution.

### (2) Preparation of Second Polyolefin Solution

To 100 parts by mass of a second polyolefin resin composed of 50% by mass of high density polyethylene (HDPE; density: 0.955 g/cm³, melting point: 135° C.) having an Mw of 5.6×10⁵, and 50% by mass of polypropylene (PP; melting point: 162° C.) having an Mw of 1.6×10⁶, 0.2 parts by mass of tetrakis[methylene-3-(3,5-ditertiarybutyl-4-hydroxyphenyl)-propionate]methane, as an antioxidant, was blended, to prepare a mixture. Into another twin screw extruder of the same type as described above, 30 parts by mass of the resulting mixture was introduced, and 70 parts by mass of liquid paraffin [35 cst (40° C.)] was supplied via a side feeder of the twin screw extruder, followed by melt-blending the resultant under the conditions of 230° C. and 150 rpm, to prepare a second polyolefin solution.

### (3) Extrusion

The first and the second polyolefin solutions were supplied from the respective twin screw extruders to a T die for three layers, and extruded such that the layer thickness ratio of the first polyolefin solution/the second polyolefin solution/the first polyolefin solution was 40/20/40. The extruded molding was then taken up by a chill roll controlled to 30° C., and cooled while taking up the molding at a speed of 4 m/min, to form a gel-like three-layer sheet.

### (4) First Stretching, Removal of Membrane-forming Solvent, and Drying

The thus formed gel-like three-layer sheet was simultaneously biaxially stretched 5×5 times at 113° C. by a tenter stretching machine. Thereafter, while keeping the stretched sheet in a state fixed by clips, the sheet was subjected to heat setting at 119° C., which is a temperature 6° C. higher than the stretching temperature, and for 15 seconds, to obtain a stretched membrane. The resulting stretched membrane was washed with methylene chloride to extract and remove the residual liquid paraffin, followed by drying. The blending ratio of the respective components, production conditions, evaluation results and the like of the thus produced polyolefin three-layer microporous membrane are shown in Table 1.

### Example 2

A polyolefin three-layer microporous membrane was produced under the same conditions as Example 1, except that, in the formation of the polyolefin microporous membrane, the gel-like three-layer sheet was simultaneously biaxially stretched 5×5 times at 116° C., and then subjected to heat setting at 119° C., which is a temperature 3° C. higher than the stretching temperature, to obtain a stretched membrane. The blending ratio of the respective components, production conditions, evaluation results and the like of the thus produced polyolefin three-layer microporous membrane are shown in Table 1.

### Example 3

A polyolefin three-layer microporous membrane was produced under the same conditions as Example 1, except that the gel-like three-layer sheet was simultaneously biaxially stretched 5×5 times at 114° C., and then subjected to heat setting at 122° C., which is a temperature 8° C. higher than the stretching temperature, to obtain a stretched membrane. The blending ratio of the respective components, production conditions, evaluation results and the like of the thus produced polyolefin three-layer microporous membrane are shown in Table 1.

### Comparative Example 1

To 100 parts by mass of a polyethylene resin composed of 40% by mass of ultra-high molecular weight polyethylene (UHPE) having an Mw of 2.0×10⁶, and 60% by mass of high density polyethylene (HDPE) having an Mw of 5.6×10⁵, 0.2 parts by mass of tetrakis[methylene-3-(3,5-ditertiarybutyl-4-hydroxyphenyl)-propionate]methane, as an antioxidant, was blended, to prepare a mixture. Into a strong-blending twin screw extruder, 25 parts by mass of the resulting mixture was introduced, and 75 parts by mass of liquid paraffin [35 cSt (40° C.)] was supplied via a side feeder of the twin screw extruder, followed by melt-blending the resultant under the conditions of 230° C. and 250 rpm, to prepare a polyolefin solution. The resulting polyolefin solution was supplied from the twin screw extruder to a T die, and extruded such that a molding in the form of gel-like sheet was obtained.

The thus formed gel-like sheet was simultaneously biaxially stretched 5×5 times at 112° C., and then subjected to heat setting at 122° C., which is a temperature 10° C. higher than the stretching temperature, to obtain a stretched membrane. The resulting stretched membrane was washed with methylene chloride to extract and remove the residual liquid paraffin, followed by drying.

The blending ratio of the respective components, production conditions, evaluation results and the like of the thus produced polyolefin microporous membrane are shown in Table 1.

### Comparative Example 2

To 100 parts by mass of a polyethylene resin composed of 18% by mass of ultra-high molecular weight polyethylene (UHPE) having an Mw of 2.0×10⁶, and 82% by mass of high density polyethylene (HDPE) having an Mw of 5.6×10⁵, 0.2 parts by mass of tetrakis[methylene-3-(3,5-ditertiarybutyl-4-hydroxyphenyl)-propionate]methane, as an antioxidant, was blended, to prepare a mixture.

Into a strong-blending twin screw extruder, 25 parts by mass of the resulting mixture was introduced, and 75 parts by mass of liquid paraffin [35 cSt (40° C.)] was supplied via a side feeder of the twin screw extruder, followed by melt-blending the resultant under the conditions of 230° C. and 250 rpm, to prepare a polyolefin solution. The resulting polyolefin solution was supplied from the twin screw extruder to a T die, and extruded such that a molding in the form of gel-like sheet was obtained. The thus formed gel-like sheet was simultaneously biaxially stretched 5×5 times at 117° C., and then subjected to heat setting at 95° C., which is a temperature 22° C. lower than the stretching temperature, to obtain a stretched membrane. The resulting stretched membrane was washed with methylene chloride to extract and remove the residual liquid paraffin, followed by drying.

### Comparative Example 3

To 100 parts by mass of a polyolefin resin composed of 50% by mass of high density polyethylene (HDPE) having an Mw of 5.6×10⁵ and 50% by mass of polypropylene (PP) having an Mw of 1.6×10⁶, 0.2 parts by mass of tetrakis[methylene-3-(3,5-ditertiarybutyl-4-hydroxyphenyl)-propionate]methane, as an antioxidant, was blended, to prepare a mixture. Into a strong-blending twin screw extruder, 35 parts by mass of the resulting mixture was introduced, and 65 parts by mass of liquid paraffin [35 cSt (40° C.)] was supplied via a side feeder of the twin screw extruder, followed by melt-blending the resultant under the same conditions as described above, to prepare a polyolefin solution. The resulting polyolefin solution was supplied from the twin screw extruder to a T die, and extruded such that a molding in the form of gel-like sheet was obtained.

The thus formed gel-like sheet was simultaneously biaxially stretched 5×5 times at 115° C., and then subjected to heat setting at 95° C., which is a temperature 20° C. lower than the stretching temperature, to obtain a stretched membrane. The resulting stretched membrane was washed with methylene chloride to extract and remove the residual liquid paraffin, followed by drying.

### Comparative Example 4

The gel-like sheet obtained in Comparative Example 3 was simultaneously biaxially stretched 5×5 times at 118° C., and then subjected to heat setting at 95° C., which is a temperature 23° C. lower than the stretching temperature, to obtain a stretched membrane. The resulting stretched membrane was washed with methylene chloride to extract and remove the residual liquid paraffin, followed by drying.

### Comparative Example 5

To 100 parts by mass of a polyolefin resin composed of 70% by mass of high density polyethylene (HDPE) having an Mw of 5.6×10⁵ and 30% by mass of polypropylene (PP) having an Mw of 1.6×10⁶, 0.2 parts by mass of tetrakis[methylene-3-(3,5-ditertiarybutyl-4-hydroxyphenyl)-propionate]methane, as an antioxidant, was blended, to prepare a mixture. Into a strong-blending twin screw extruder, 35 parts by mass of the resulting mixture was introduced, and 65 parts by mass of liquid paraffin [35 cSt (40° C.)] was supplied via a side feeder of the twin screw extruder. Except for the above, the resultant was melt-blended under the same conditions as Comparative Example 4, to prepare a polyolefin solution.

### Comparative Example 6

To 100 parts by mass of a polyethylene resin composed of 30% by mass of ultra-high molecular weight polyethylene (UHPE) having an Mw of 2.0×10⁶, and 70% by mass of high density polyethylene (HDPE) having an Mw of 5.6×10⁵, 0.2 parts by mass of tetrakis[methylene-3-(3,5-ditertiarybutyl-4-hydroxyphenyl)-propionate]methane, as an antioxidant, was blended, to prepare a mixture. Into a strong-blending twin screw extruder, 28.5 parts by mass of the resulting mixture was introduced, and 71.5 parts by mass of liquid paraffin [35 cSt (40° C.)] was supplied via a side feeder of the twin screw extruder, followed by melt-blending the resultant under the conditions of 230° C. and 250 rpm, to prepare a first polyolefin solution.

To 100 parts by mass of a polyolefin resin composed of 50% by mass of high density polyethylene (HDPE) having an Mw of 5.6×10⁵ and 50% by mass of polypropylene (PP) having an Mw of 1.6×10⁶, 0.2 parts by mass of tetrakis[methylene-3-(3,5-ditertiarybutyl-4-hydroxyphenyl)-propionate]methane, as an antioxidant, was blended, to prepare a mixture. Into another twin screw extruder of the same type as described above, 22.5 parts by mass of the resulting mixture was introduced, and 77.5 parts by mass of liquid paraffin [35 cst (40° C.)] was supplied via a side feeder of the twin screw extruder, followed by melt-blending the resultant under the conditions of 230° C. and 150 rpm, to prepare a second polyolefin solution.

The first and the second polyolefin solutions were supplied from the respective twin screw extruders to a T die for three layers, and extruded such that the layer thickness ratio of the second polyolefin solution/the first polyolefin solution/the second polyolefin solution was 10/80/10, to form a gel-like three-layer sheet. The thus formed gel-like three-layer sheet was simultaneously biaxially stretched 5×5 times at 116° C., and then subjected to heat setting at 95° C., which is a temperature 21° C. lower than the stretching temperature, to obtain a stretched membrane. The resulting stretched membrane was washed with methylene chloride to extract and remove the residual liquid paraffin, followed by drying.

### Comparative Example 7

The first and the second polyolefin solutions obtained in Comparative Example 6 were supplied from the respective twin screw extruders to a T die for three layers, and extruded such that the layer thickness ratio of the second polyolefin solution/the first polyolefin solution/the second polyolefin solution was 15/70/15, to form a gel-like three-layer sheet. The thus formed gel-like sheet was simultaneously biaxially stretched 5×5 times at 116° C., and then subjected to heat setting at 95° C., which is a temperature 21° C. lower than the stretching temperature, to obtain a stretched membrane. The resulting stretched membrane was washed with methylene chloride to extract and remove the residual liquid paraffin, followed by drying.

### Comparative Example 8

To 100 parts by mass of a polyethylene resin composed of 40% by mass of ultra-high molecular weight polyethylene (UHPE) having an Mw of 2.0×10⁶, and 60% by mass of high density polyethylene (HDPE) having an Mw of 5.6×10⁵, 0.2 parts by mass of tetrakis[methylene-3-(3,5-ditertiarybutyl-4-hydroxyphenyl)-propionate]methane, as an antioxidant, was blended, to prepare a mixture. Into a strong-blending twin screw extruder, 25 parts by mass of the resulting mixture was introduced, and 72.5 parts by mass of liquid paraffin [35 cSt (40° C.)] was supplied via a side feeder of the twin screw extruder, followed by melt-blending the resultant under the conditions of 230° C. and 250 rpm, to prepare a first polyolefin solution.

To 100 parts by mass of a polyolefin resin composed of 50% by mass of high density polyethylene (HDPE) having an Mw of 5.6×10⁵ and 50% by mass of polypropylene (PP) having an Mw of 1.6×10⁶, 0.2 parts by mass of tetrakis[methylene-3-(3,5-ditertiarybutyl-4-hydroxyphenyl)-propionate]methane, as an antioxidant, was blended, to prepare a mixture. Into another twin screw extruder of the same type as described above, 30 parts by mass of the resulting mixture was introduced, and 70 parts by mass of liquid paraffin [35 cst (40° C.)] was supplied via a side feeder of the twin screw extruder, followed by melt-blending the resultant under the conditions of 230° C. and 150 rpm, to prepare a second polyolefin solution.

The first and the second polyolefin solutions were supplied from the respective twin screw extruders to a T die for three layers, and extruded such that the layer thickness ratio of the first polyolefin solution/the second polyolefin solution/the first polyolefin solution was 42.5/15/42.5, to form a gel-like three-layer sheet. The thus formed gel-like three-layer sheet was simultaneously biaxially stretched 5×5 times at 113° C., and then subjected to heat setting at 100° C., which is a temperature 13° C. lower than the stretching temperature, to obtain a stretched membrane. The resulting stretched membrane was washed with methylene chloride to extract and remove the residual liquid paraffin, followed by drying.

### Comparative Example 9

The first and the second polyolefin solutions obtained in Comparative Example 8 were supplied from the respective twin screw extruders to a T die for three layers, and extruded such that the layer thickness ratio of the second polyolefin solution/the first polyolefin solution/the second polyolefin solution was 40/20/40, to form a gel-like three-layer sheet. The thus formed gel-like sheet was simultaneously biaxially stretched 5×5 times at 113° C., and then subjected to heat setting at 95° C., which is a temperature 18° C. lower than the stretching temperature, to obtain a stretched membrane. The resulting stretched membrane was washed with methylene chloride to extract and remove the residual liquid paraffin, followed by drying.

TABLE 1

| | | | | | | Comparative | Comparative | Comparative | Comparative |
|---|---|---|---|---|---|---|---|---|---|
| | | | Example 1 | Example 2 | Example 3 | Example 1 | Example 2 | Example 3 | Example 4 |
| First Layer | UHPE | % by mass | 40 | 40 | 40 | 40 | 18 | — | — |
| | HDPE | % by mass | 60 | 60 | 60 | 60 | 82 | — | — |
| | PP | % by mass | — | — | — | — | — | — | — |
| Second | UHPE | % by mass | — | — | — | — | — | — | — |
| Layer | HDPE | % by mass | 50 | 50 | 50 | — | — | 50 | 50 |
| | PP | % by mass | 50 | 50 | 50 | — | — | 50 | 50 |
| Layer configuration | | — | 1/2/1 | 1/2/1 | 1/2/1 | 1 | 1 | 2 | 2 |
| Thickness ratio | | — | 40/20/40 | 40/20/40 | 40/20/40 | — | — | — | — |
| Production | Stretching | ° C. | 113 | 116 | 114 | 112 | 117 | 115 | 118 |
| conditions | temperature | | | | | | | | |
| | Setting | ° C. | 119 | 119 | 122 | 122 | 95 | 95 | 95 |
| | temperature | | | | | | | | |
| | Setting | ° C. | 6 | 3 | 8 | 10 | −22 | −20 | −23 |
| | temperature − | | | | | | | | |
| | stretching | | | | | | | | |
| | temperature | | | | | | | | |

| | | | | | | | | |
|---|---|---|---|---|---|---|---|---|
| Membrane thickness | μm | 9.2 | 9.6 | 9.5 | 10.1 | 10.3 | 11.4 | 11.8 |
| Air resistance | sec/100 cc | 130 | 110 | 160 | 180 | 60 | 510 | 470 |
| Bubble point pore size | nm | 27 | 30 | 26 | 47 | 72 | 25 | 31 |
| BP pressure | Mpa | 1.67 | 1.5 | 1.77 | 0.96 | 0.63 | 1.85 | 1.45 |
| Mean flow pore diameter | nm | 20 | 22 | 17 | 31 | 44 | 17 | 15 |
| Porosity | % | 50 | 51 | 53 | 37 | 51 | 36 | 38 |
| Amount of permeated | ml/min · cm² | 0.11 | 0.09 | 0.08 | 0.11 | 0.32 | 0.04 | 0.04 |
| water | | | | | | | | |

| | | | Comparative | Comparative | Comparative | Comparative | Comparative |
|---|---|---|---|---|---|---|---|
| | | | Example 5 | Example 6 | Example 7 | Example 8 | Example 9 |
| First Layer | UHPE | % by mass | — | 30 | 30 | 40 | 40 |
| | HDPE | % by mass | — | 70 | 70 | 60 | 60 |
| | PP | % by mass | — | — | — | — | — |
| Second | UHPE | % by mass | — | — | — | — | — |
| Layer | HDPE | % by mass | 70 | 50 | 50 | 50 | 50 |
| | PP | % by mass | 30 | 50 | 50 | 50 | 50 |
| Layer configuration | | — | 2 | 2/1/2 | 2/1/2 | 1/2/1 | 1/2/1 |
| Thickness ratio | | — | — | 10/80/10 | 15/70/15 | 42.5/15/42.5 | 40/20/40 |
| Production | Stretching | ° C. | 118 | 116 | 116 | 113 | 113 |
| conditions | temperature | | | | | | |
| | Setting | ° C. | 95 | 95 | 95 | 100 | 95 |
| | temperature | | | | | | |
| | Setting | ° C. | −23 | −21 | −21 | −13 | −18 |
| | temperature − | | | | | | |
| | stretching | | | | | | |
| | temperature | | | | | | |

| | | | | | | |
|---|---|---|---|---|---|---|
| Membrane thickness | μm | 11.7 | 12.7 | 12.7 | 8.0 | 12.0 |
| Air resistance | sec/100 cc | 180 | 230 | 240 | 360 | 220 |
| Bubble point pore size | nm | 46 | 26 | 26 | 26 | 30 |
| BP pressure | Mpa | 1.00 | 1.73 | 1.73 | 1.75 | 1.54 |
| Mean flow pore diameter | nm | 27 | 19 | 19 | 17 | 20 |
| Porosity | % | 39 | 48 | 49 | 44 | 46 |
| Amount of permeated | ml/min · cm² | 0.12 | 0.05 | 0.05 | 0.04 | 0.06 |
| water | | | | | | |

### 3. Evaluation

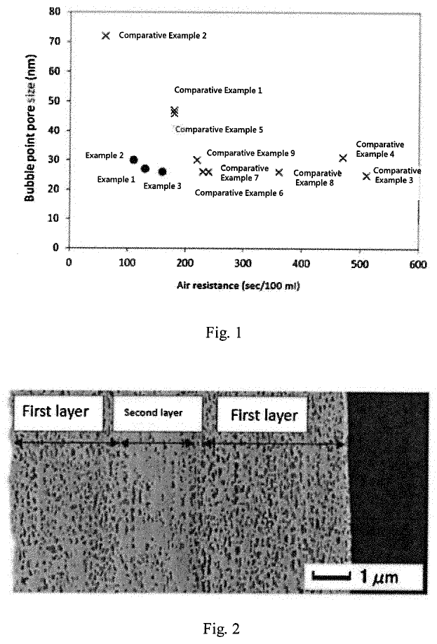

The polyolefin microporous membranes of Examples 1 to 3 have a membrane thickness of about 9 to 12.4 μm, an air resistance of 200 sec/100 ml or less, and a BP pore size of 27 to 30 nm. As shown in FIG. 1, these membranes exhibited a good balance between the BP pore size and the air resistance.

In contrast, in the polyolefin microporous membranes of Comparative Examples 1 to 9, which were produced using conventional production conditions, there is a tendency that a decrease in the BP pore size results in an increase in the air resistance as shown in FIG. 1. This reveals that the balance between the pore size and the permeability in those membranes is inferior compared to that in the polyolefin microporous membranes of the Examples.

1.-9. (canceled)

10. A polyolefin microporous membrane comprising at least a first layer and a second layer,
wherein said first layer is composed of a first polyolefin resin containing polyethylene,
said second layer is composed of a second polyolefin resin containing polyethylene and polypropylene, and
said polyolefin microporous membrane satisfies (I) and (II):
(I) said polyolefin microporous membrane has an air resistance of 10 sec/100 ml or more and 200 sec/100 ml or less; and
(II) said polyolefin microporous membrane has a bubble point pore size of 5 nm or more and 35 nm or less.

11. The polyolefin microporous membrane according to claim 10,
wherein said first polyolefin resin contains 60% by weight or more and 100% by weight or less of polyethylene with respect to 100% by weight of said first polyolefin resin;
said second polyolefin resin contains 1% by weight or more and 70% by weight or less of polyethylene and 30% by weight or more and 99% by weight or less of polypropylene with respect to 100% by weight of said second polyolefin resin; and
said first polyolefin resin has a composition different from the composition of said second polyolefin resin.

12. The polyolefin microporous membrane according to claim 10, wherein said polypropylene has a weight average molecular weight of 1×10⁵ or more and 5×10⁶ or less.

13. The polyolefin microporous membrane according to claim 10, further satisfying (III):
(III) said polyolefin microporous membrane has a mean flow pore size of 1 nm or more and 30 nm or less.

14. The polyolefin microporous membrane according to claim 10, further satisfying (IV):
(IV) said polyolefin microporous membrane has a porosity of 43% or more and 70% or less.

15. The polyolefin microporous membrane according to claim 10, further satisfying (V):
(V) said polyolefin microporous membrane has a membrane thickness of 1 μm or more and 25 μm or less.

16. A filtration filter comprising said polyolefin microporous membrane according to claim 10.

17. A filtration apparatus comprising said filtration filter according to claim 16, wherein, in said filtration filter, at least said first layer and said second layer are arranged in the order mentioned, from the upstream side relative to the flow of a fluid to be filtered.

18. A battery separator comprising said polyolefin microporous membrane according to claim 10.
